(19) United States
(12) Patent Application Publication
(10) Pub. No.: US 2014/0122663 A1
(43) Pub. Date: May 1, 2014

(54) OVERLOAD PROTECTION BASED ON WEB TRAFFIC VOLUMES

(71) Applicant: Brown Paper Tickets LLC, Seattle, WA (US)

(72) Inventors: William Scott Jordan, Edmonds, WA (US); Kevin Johnathan Neff, Seattle, WA (US)

(73) Assignee: BROWN PAPER TICKETS LLC, Seattle, WA (US)

(21) Appl. No.: 14/069,270

(22) Filed: Oct. 31, 2013

Related U.S. Application Data
(60) Provisional application No. 61/720,841, filed on Oct. 31, 2012.

(51) Int. Cl. H04L 12/26; H04L 29/08

(52) U.S. Cl. CPC H04L 43/0876; H04L 67/02
USPC 709/219

(57) ABSTRACT

A system is engineered for handling overwhelming volumes of web traffic in a way that reduces or prevents server and database overload. A traffic overload protector is suitable for detecting traffic spikes on dynamic web pages for specific events or items and redirects users to pre-generated static web pages hosted on a secondary server. The static web pages are created when a new event is created and added to a ticketing system, or when an item sales page is created for an e-commerce system.

### CROSS-REFERENCE TO RELATED APPLICATION

This application claims the benefit of Provisional Application No. 61/720841, filed Oct. 31, 2012, which is incorporated herein by reference.

### TECHNICAL FIELD

The subject matter is generally related to regulating web traffic, and more particularly, it relates to web traffic analytics so as to inhibit web traffic overload.

### BACKGROUND

Web traffic is the amount of data sent and received by visitors to web sites. For several decades, web traffic has been the largest portion of internet traffic. This is determined by the number of visitors and the number of pages they visit. Sites monitor the incoming and outgoing traffic to see which parts or pages of their site are popular and if there are any apparent trends, such as one specific page being viewed mostly by people in a particular country. Too much web traffic can dramatically slow down or even prevent all access to a web site. This is caused by more file requests going to the server than it can handle and may be caused by over-popularity. Sudden traffic load may also hang a web server or may result in the shutdown of e-commerce services.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect includes a system form of the subject matter that recites a system which comprises a primary server which hardware structure is suitable for serving dynamic web pages, a secondary server which hardware structure is capable of serving static web pages, and a traffic overload protector which hardware structure has a capacity to detect spikes in internet traffic directed to one or more dynamic web pages on the primary server and further having the capacity to inhibit traffic overload by redirecting the internet traffic to the static web pages on the secondary server.

Another aspect includes a method form of the subject matter that recites a method, which comprises counting a count of a number of page views for a dynamic web page, detecting whether the count exceeds an overload threshold within a time period, and redirecting internet traffic to a static web page.

A further aspect includes a computer-readable medium form of the subject matter that recites a computer-readable medium, which is non-transitory, having computer-executable instructions stored thereon to implement a method. The method comprises counting a count of a number of page views for a dynamic web page, detecting whether the count exceeds an overload threshold within a time period, and redirecting internet traffic to a static web page.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an archetypical system in accordance with one embodiment of the present subject matter; and

FIGS. 2A-2F are process diagrams illustrating an archetypical method to inhibit overloading of a server or a database in accordance with numerous embodiments of the present subject matter.

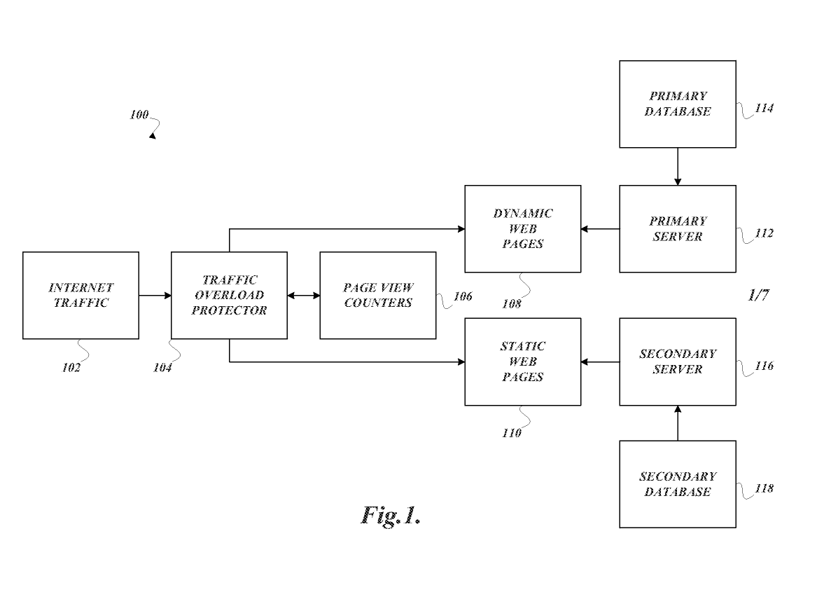

### DETAILED DESCRIPTION

Various embodiments of the present subject matter engineer a system 100, which comprises hardware structures for handling overwhelming volumes of web traffic in a way that reduces or prevents server and database overload. A traffic overload protector 104 is a hardware structure suitable for detecting traffic spikes on dynamic web pages 108 for specific events or items and redirects users to pre-generated static web pages 110 hosted on a secondary server 116, which is also a hardware structure. The static web pages 110 are created when new events are created and added to a ticketing system (such as the system 100), or when item sales pages are created for an e-commerce system (also, such as the system 100). Any suitable tag-based language may be used to describe the static web pages 110, including HTML.

In an HTML example, a static HTML version of the dynamic web page is created and uploaded to a secondary server 116 in combination with a secondary database 118, which is a hardware structure. One illustrative example of the secondary server 116 includes a third-party web hosting service. The static web page is nearly identical to the event or item's dynamic web page, except the static web page is marked with a “SOLD OUT” message instead of the corresponding dynamic web page's “BEGIN ORDER” option. The following for illustrative purposes only describes an application of the system 100 to subject matter involving a ticketing system or a system that facilitates e-commerce of items, but it would be appreciated by one skilled in the art that the subject matter is applicable to any web site that has dynamic web pages. On such a web site, the use of the system 100 alleviates sudden traffic spikes.

The users, who wish to purchase tickets to an event or purchase an item of commerce, access the system 100 by entering a web address (connected with the event or the item) or clicking on a link on a web page (that is also connected with the event or the item). Such clicking from one or more users generates internet traffic 102 directed toward the system 100, and specifically, a primary server 112, which is a hardware structure, and its primary database 114, which is another hardware structure. In one embodiment, the primary server 112 is a web server. The primary server 112, in combination with the primary database 114, serves the dynamic web pages 108, one of which is connected with the event or item of commerce desired by the users.

The internet traffic 102 is introduced to the traffic overload protector 104. The traffic overload protector 104 uses page view counters 106, which are hardware structures capable of counting the number of page views for each of the dynamic web pages 108. In one embodiment, the primary server 112 counts the number of page views for each of its dynamic web pages 108. If the traffic overload protector 104 detects that traffic for any one event or item listing reaches an overload threshold (such as 75% of the system's pre-determined maximum capacity) during a time period (such as any 10 second period), all additional dynamic web page requests for that event or item listing cause the traffic overload protector 104 to return a simple HTTP redirect or Javascript redirect to the pre-generated static web page 110 for that event or item on the secondary server 116. Redirects continue to be served for new page requests for a suitable redirect time period, such as 60 seconds following the trigger event.

Regarding traffic reduction, because HTTP and Javascript redirects require a fraction of the bandwidth needed to serve the full HTML for either the event's scheduling page or the item's purchase page, and because the system 100 does not require any database interaction to serve the redirects, both bandwidth and server load are greatly reduced during the redirect periods. Additionally, redirected users using their browser reload function to check for new ticket availability on the event page or availability of the inventory item are polling the secondary server 116 and do not add any additional load to the primary server 112. In some embodiments, additional traffic during the redirect period on the primary server 112 can refresh the redirect period if it continues to surpass the overload threshold (such as surpassing the 75% capacity trigger point). In a few embodiments, the static web pages 110 on the secondary server 116 should have a similar URL to the dynamic web page listing. This helps to prevent users from knowing they have been redirected. For example, if a dynamic web page item listing can be found at http://www.example.com/item/1234, the static web page listing should be hosted at http://ww2.example.com/item/1234.

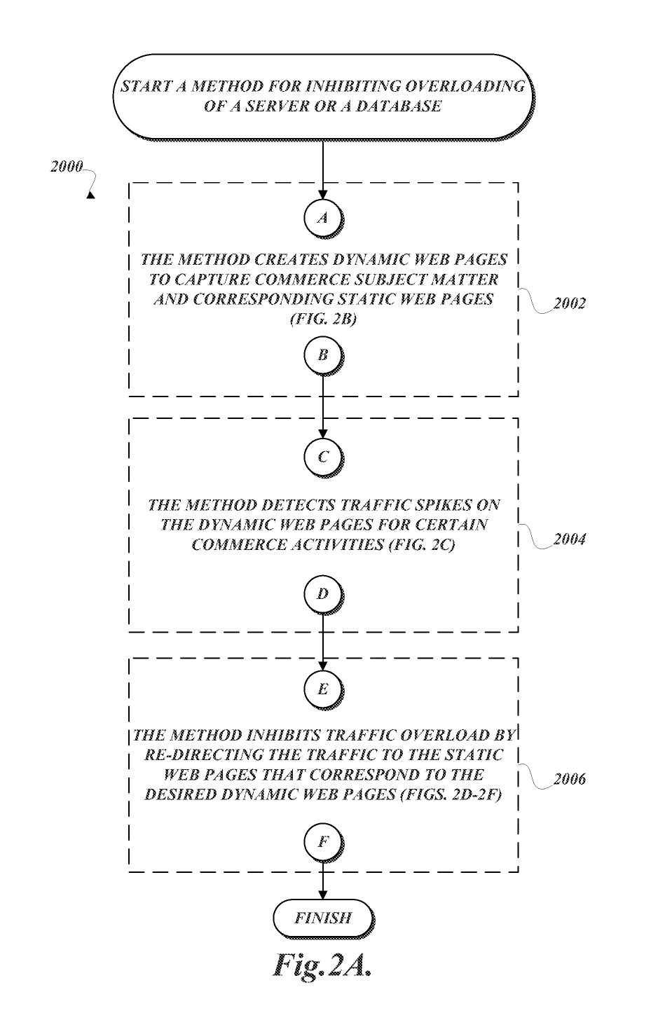

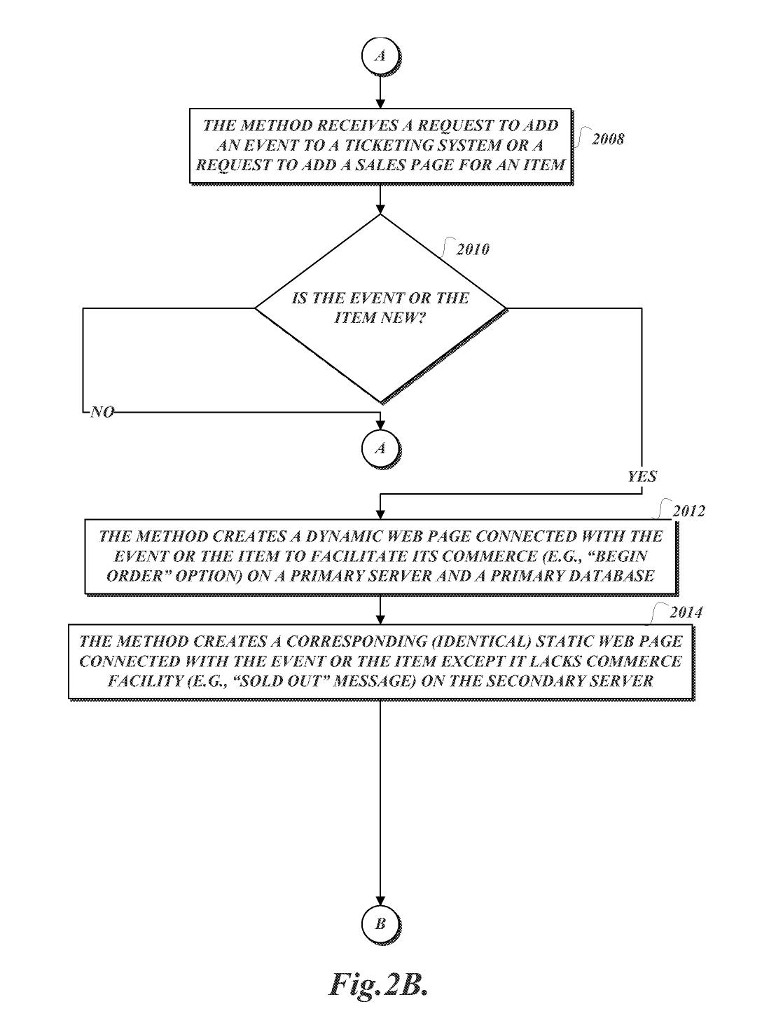

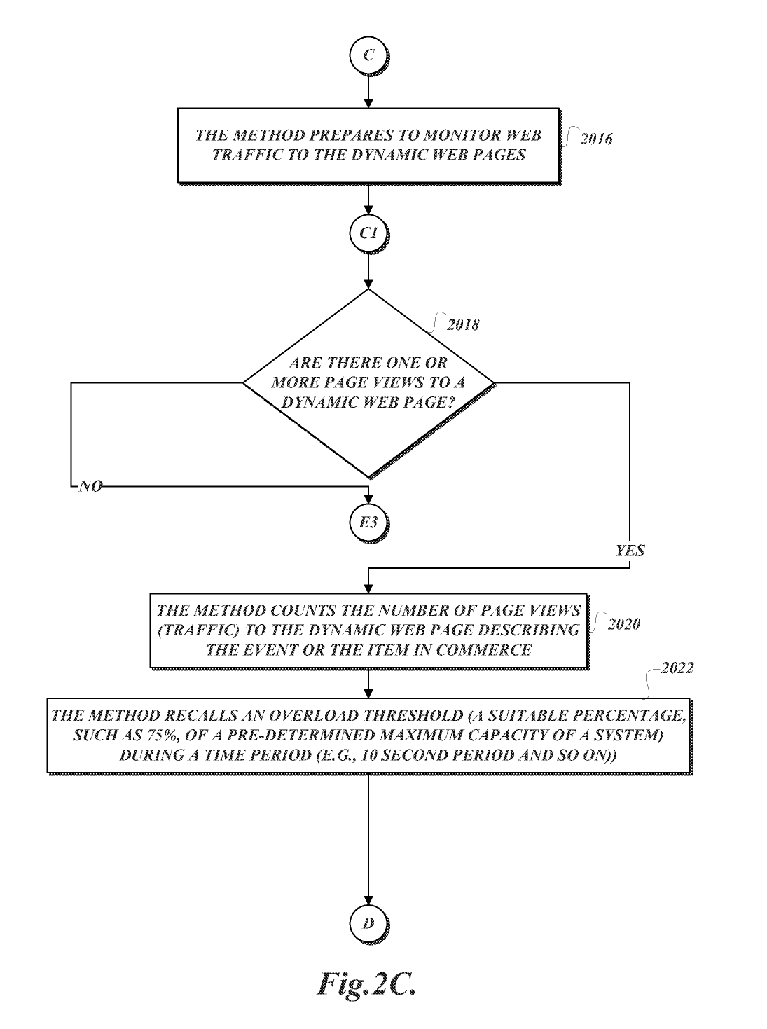

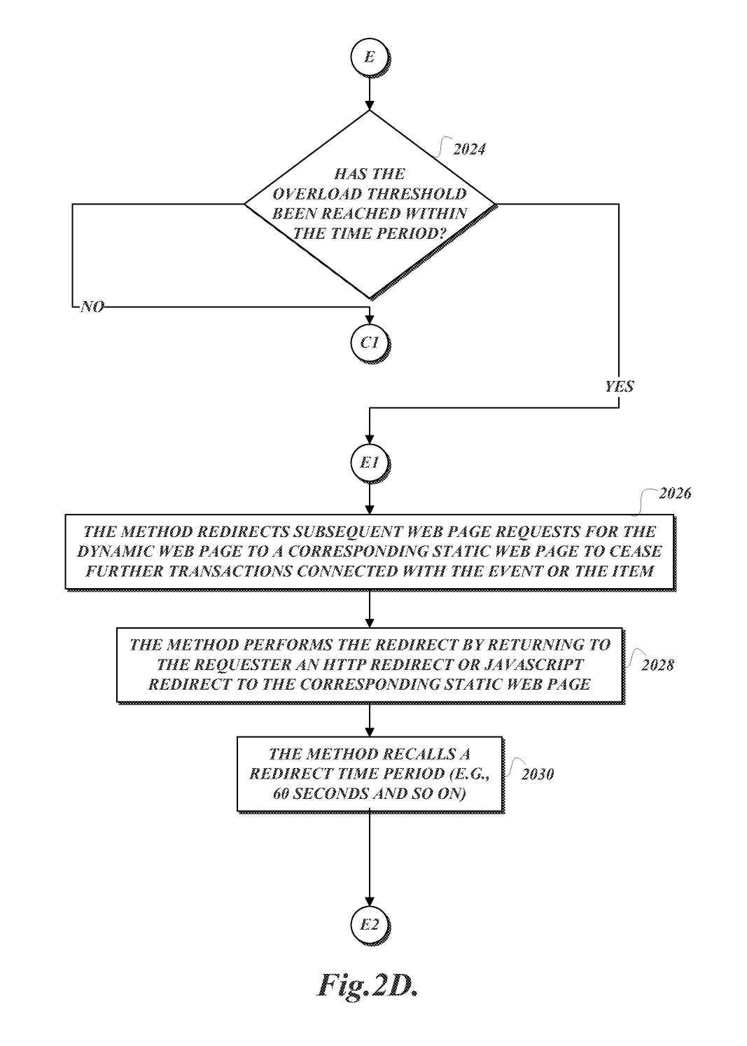

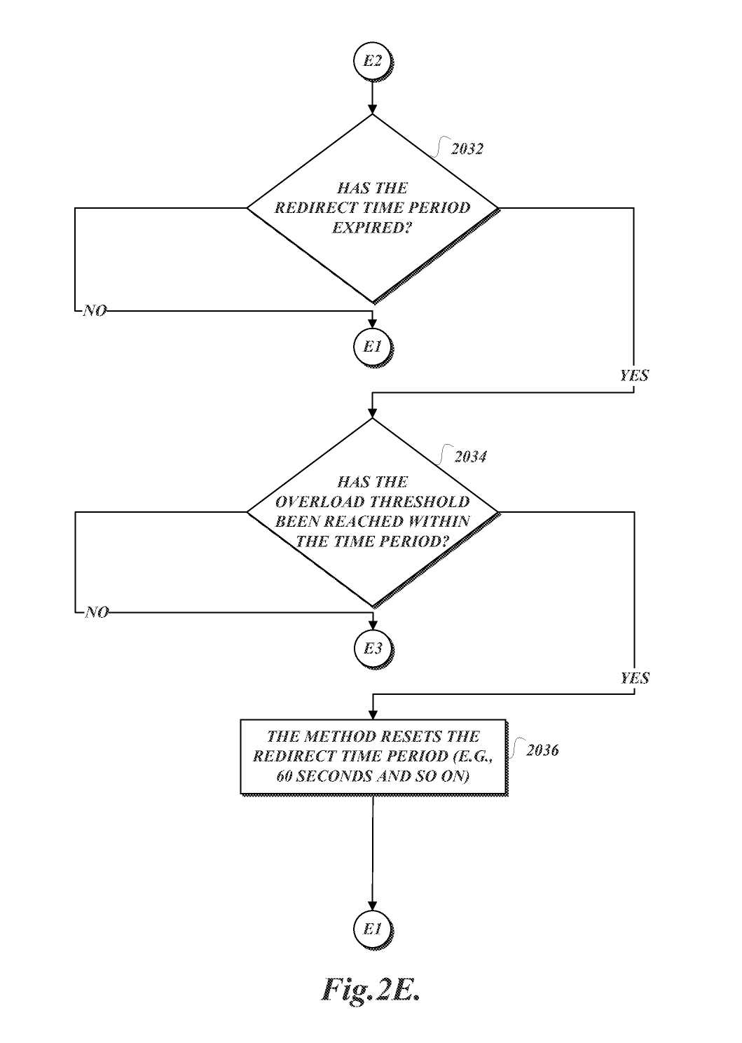

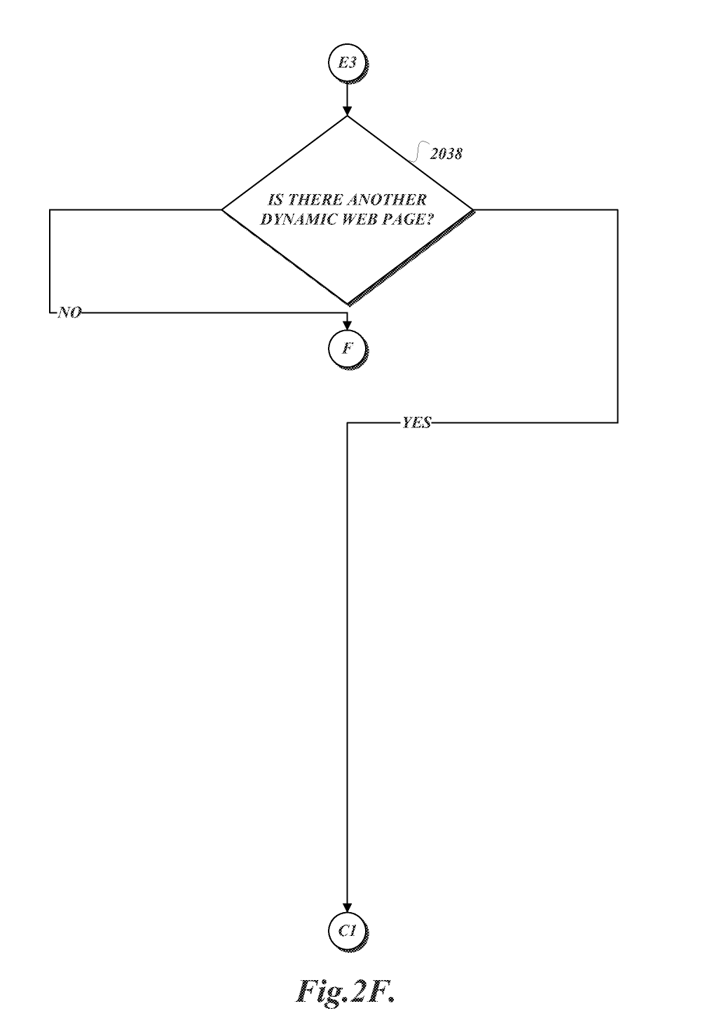

FIGS. 2A-2F are process diagrams implementing a method 2000 for inhibiting overloading of a server or a database. From a start block, the method 2000 proceeds to a set of method steps 2002 defined between a continuation terminal (“terminal A”) and another continuation terminal (“terminal B”). The set of method steps 2002 executes steps having the capacity to create dynamic web pages to capture commerce subject matter and corresponding static web pages. From terminal A (FIG. 2B), the method proceeds to block 2008 where the method receives a request to add an event to a ticketing system or a request to add a sales page for an item. The method then progresses to decision block 2010, where a test is performed to determine whether the event or the item is new. If the answer to the test at decision block 2010 is NO, the method enters terminal A and skips back to block 2008 where the above-identified processing steps are repeated.

Otherwise, if the answer to the test at decision block 2010 is YES, the method proceeds to block 2012, where the method creates a dynamic web page connected with the event or the item to facilitate its commerce (e.g., “BEGIN ORDER” option) on a primary server and/or a primary database. The method also progresses to block 2014 where the method creates a corresponding (identical) static web page connected with the event or the item, except that it lacks commerce facility (e.g., shows a “SOLD OUT” message) on the secondary server. The method then continues to terminal B.

From terminal B (FIG. 2A), the method 2000 proceeds to a set of method steps 2004 defined between a continuation terminal (“terminal C”) and another continuation terminal (“terminal D”). The set of method steps 2004 executes steps suitable for detecting traffic spikes on the dynamic web pages for certain commerce activities. From terminal C (FIG. 2C), the method 2000 proceeds to block 2016, where the method prepares to monitor web traffic to the dynamic web pages. The method then enters into another continuation terminal (“terminal C1”). From terminal C1 (FIG. 2C), the method proceeds to decision block 2018 where a test is performed to determine whether there are one or more page views to a dynamic web page. If the answer to the test at decision block 2018 is NO, the method enters into another continuation terminal (“terminal E3”). Otherwise, if the answer to the test at decision block 2018 is YES, the method proceeds to block 2020, where the method counts the number of page views (traffic) to the dynamic web page describing the event or the item in commerce. At block 2022, the method recalls an overload threshold (a suitable percentage, such as 75%, of a pre-determined maximum capacity of a system) during a time period (e.g., a 10-second period and so on). The method then continues to terminal D.

From terminal D (FIG. 2A), the method 2000 proceeds to a set of method steps 2006 defined between a continuation terminal (“terminal E”) and another continuation terminal (“terminal F”). The set of method steps 2006 executes steps being capable of inhibiting traffic overload by re-directing the traffic to the static web pages that correspond with the desired dynamic web pages. From terminal E (FIG. 2D), the method proceeds to decision block 2024, where a test is performed to determine whether the overload threshold has been reached within the time period. If the answer to the test at decision block 2024 is NO, the method continues to terminal C1 and skips back to decision block 2018 where the above-identified processing steps are repeated. Otherwise, the answer to the test at decision block 2024 is YES, and the method proceeds to another continuation terminal (“terminal E1”).

From terminal E1 (FIG. 2D), the method proceeds to block 2026, where the method redirects subsequent web page requests for the dynamic web page to a corresponding static web page to cease further transactions connected with the event or the item. At block 2028, the method performs the redirect by returning to the requester an HTTP redirect or Javascript redirect to the corresponding static web page. At block 2030, the method recalls a redirect time period (e.g., 60 seconds and so on). The method then continues to another continuation terminal (“terminal E2”).

From terminal E2 (FIG. 2E), the method proceeds to decision block 2032, where a test is performed to determine whether the redirect time period has expired. If the answer to the test at decision block 2032 is NO, the method continues to terminal E1 and skips back to block 2026 where the above-identified processing steps are repeated. Otherwise, if the answer to the test at decision block 2032 is YES, the method continues to decision block 2034, where another test is performed to determine whether the overload threshold has been reached within the time period. If the answer to the test at decision block 2034 is NO, the method continues to another continuation terminal (“terminal E3”). Otherwise, if the answer to the test at decision block 2034 is YES, the method continues to block 2036, where the method resets the redirect time period (e.g., 60 seconds and so on). The method then continues to terminal E1 and skips back to block 2026, where the above-identified processing steps are repeated.

From terminal E3 (FIG. 2F), the method proceeds to decision block 2038 where a test is performed to determine whether there is another dynamic web page. If the answer to the test at decision block 2038 is NO, the method enters terminal F and terminates execution. Otherwise, if the answer to the test at decision block 2038 is YES, the method enters terminal C1 and skips back to decision block 2018 to execute the above-identified processing steps.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system, comprising:
a primary server which hardware structure is suitable for serving dynamic web pages;
a secondary server which hardware structure is capable of serving static web pages; and
a traffic overload protector which hardware structure has a capacity to detect spikes in internet traffic directed to one or more dynamic web pages on the primary server and further having the capacity to inhibit traffic overload by redirecting the internet traffic to the static web pages on the secondary server.

2. The system of claim 1, further comprising page view counters, each page view counter being a hardware structure suitable for counting page views on a dynamic web page so as to assist the traffic overload protector to detect a traffic spike.

3. The system of claim 2, further comprising a primary database.

4. The system of claim 3, further comprising a secondary database.

5. A method, comprising:
counting a count of a number of page views for a dynamic web page;
detecting whether the count exceeds an overload threshold within a time period; and
redirecting internet traffic to a static web page.

6. The method of claim 5, further comprising creating the static web page so that it identically corresponds with the dynamic web page except that the static web page lacks commerce facility.

7. The method of claim 5, wherein the overload threshold includes seventy-five percent of a pre-determined maximum capacity of a server.

8. The method of claim 7, wherein the time period includes 10 seconds.

9. The method of claim 8, wherein redirecting includes returning to a requester an HTTP redirect or a Javascript redirect to the static web page during a redirect time period.

10. The method of claim 9, wherein the redirect time period is 60 seconds.

11. The method of claim 10, further evaluating whether the overload threshold has been reached within the time period inside the redirect time period.

12. The method of claim 11, resetting a new redirect time period if the overload threshold has been reached within the time period inside the redirect time period.

13. A computer-readable medium, which is non-transitory, having computer-executable instructions stored thereon to implement a method, comprising:
counting a count of a number of page views for a dynamic web page;
detecting whether the count exceeds an overload threshold within a time period; and
redirecting internet traffic to a static web page.

14. The computer-readable medium of claim 13, further comprising creating the static web page so that it identically corresponds with the dynamic web page, except that the static web page lacks commerce facility.

15. The computer-readable medium of claim 13, wherein the overload threshold includes seventy-five percent of a pre-determined maximum capacity of a server.

16. The computer-readable medium of claim 15, wherein the time period includes 10 seconds.

17. The computer-readable medium of claim 16, wherein redirecting includes returning to a requester an HTTP redirect or a Javascript redirect to the static web page during a redirect time period.

18. The computer-readable medium of claim 17, wherein the redirect time period is 60 seconds.

19. The computer-readable medium of claim 18, further evaluating whether the overload threshold has been reached within the time period inside the redirect time period.

20. The computer-readable medium of claim 19, resetting a new redirect time period if the overload threshold has been reached within the time period inside the redirect time period.
